(19) United States
(12) Patent Application Publication
(10) Pub. No.: US 2015/0078334 A1
(43) Pub. Date: Mar. 19, 2015

(54) APPARATUS AND METHODS OF EFFICIENT SIB READING DURING WCDMA ACQUISITION IN MULTI-SIM MODEMS

(71) Applicant: QUALCOMM Incorporated, San Diego, CA (US)

(72) Inventors: Praveen PERURU, Hyderabad (IN); Karthikeyan SABAPATHI, Hyderabad (IN); Narendra PULICHERLA, Hyderabad (IN)

(73) Assignee: QUALCOMM Incorporated, San Diego, CA (US)

(21) Appl. No.: 14/230,994

(22) Filed: Mar. 31, 2014

Related U.S. Application Data
(60) Provisional application No. 61/877,756, filed on Sep. 13, 2013.

(51) Int. Cl. H04W 72/04; H04W 76/02; H04W 88/06; H04W 36/14

(52) U.S. Cl. CPC H04W 72/0446; H04W 36/14; H04W 76/02; H04W 88/06
USPC 370/331; 370/328

(57) ABSTRACT

Methods and apparatus are described for a method of cell acquisition, comprising obtaining, during an idle mode, a primary scrambling code (PSC) of a first cell of a first radio access technology (RAT) by a user equipment having a first subscription to the first RAT and a second subscription to a second RAT. Further, the methods and apparatus include performing a system information block (SIB) reading procedure for the first cell for one or more SIBs. Additionally, the methods and apparatus include determining whether any of the one or more SIBs are successfully decoded within a first time threshold during the SIB reading procedure for the first cell. Moreover, the methods and apparatus include aborting the SIB reading procedure for the first cell when the one or more SIBs are not successfully decoded within the first time threshold.

### CLAIM OF PRIORITY UNDER 35 U.S.C. §119

The present Application for Patent claims priority to U.S. Provisional Application No. 61/877,756 entitled “APPARATUS AND METHODS OF EFFICIENT SIB READING DURING WCDMA ACQUISITION IN MULTI-SIM MODEMS” filed Sep. 13, 2013, and assigned to the assignee hereof and hereby expressly incorporated by reference.

### BACKGROUND

Aspects of the present disclosure relate generally to wireless communication systems, and more particularly to processing communications related to multiple subscriptions.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless networks, a user equipment (UE) can have multiple subscriptions to one or more networks (e.g., by employing multiple subscriber identity module (SIM) cards or otherwise). Such a UE may include, but is not limited to, a dual-SIM, dual standby (DSDS) device. For example, a first subscription may a first technology standard, such as Wideband Code Division Multiple Access (WCDMA), while a second subscription may support a second technology standard, such as Global System for Mobile Communications (GSM) Enhanced Data rates for GSM Evolution (EDGE) (also referred to as GERAN). During a cell acquisition process on a WCDMA cell, problems may occur due to certain circumstances. Therefore, improvements in the acquisition operation are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, methods and apparatus for cell acquisition, comprising obtaining, during an idle mode, a primary scrambling code (PSC) of a first cell of a first radio access technology (RAT) by a user equipment having a first subscription to the first RAT and a second subscription to a second RAT. Further, the methods and apparatus include performing a system information block (SIB) reading procedure for one or more SIBs. Additionally, the methods and apparatus include determining whether any of the one or more SIBs are successfully decoded within a first time threshold during the SIB reading procedure. Moreover, the methods and apparatus include aborting the SIB reading procedure for the first cell when the one or more SIBs are not successfully decoded within the first time threshold.

In accordance with an aspect, an apparatus for cell acquisition comprises means for obtaining, during an idle mode, a primary scrambling code (PSC) of a first cell of a first radio access technology (RAT) by a user equipment having a first subscription to the first RAT and a second subscription to a second RAT. Further, the apparatus includes means for performing a system information block (SIB) reading procedure for one or more SIBs. Additionally, the apparatus includes means for determining whether any of the one or more SIBs are successfully decoded within a first time threshold during the SIB reading procedure. Moreover, the apparatus includes means for aborting the SIB reading procedure for the first cell when the one or more SIBs are not successfully decoded within the first time threshold.

Further aspects provide a computer program product for cell acquisition comprising a computer-readable medium includes at least one instruction for obtaining, during an idle mode, a primary scrambling code (PSC) of a first cell of a first radio access technology (RAT) by a user equipment having a first subscription to the first RAT and a second subscription to a second RAT. Further, the computer program product further includes at least one instruction for performing a system information block (SIB) reading procedure for one or more SIBs. Additionally, the computer program product further includes at least one instruction for determining whether any of the one or more SIBs are successfully decoded within a first time threshold during the SIB reading procedure. Moreover, the computer program product further includes at least one instruction for aborting the SIB reading procedure for the first cell when the one or more SIBs are not successfully decoded within the first time threshold.

In an additional aspect, an apparatus for communication comprises a memory storing executable instructions and a processor in communication with the memory, wherein the processor is configured to execute the instructions to obtain, during an idle mode, a primary scrambling code (PSC) of a first cell of a first radio access technology (RAT) by a user equipment having a first subscription to the first RAT and a second subscription to a second RAT. The processor is further configured to perform a system information block (SIB) reading procedure for one or more SIBs. Additionally, the processor is configured to determine whether any of the one or more SIBs are successfully decoded within a first time threshold during the SIB reading procedure. Moreover, the processor is configured to abort the SIB reading procedure for the first cell when the one or more SIBs are not successfully decoded within the first time threshold.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram of a communication network including an aspect of a user equipment that may perform a SIB reading procedure;

FIG. 2 is a schematic diagram of an aspect of the acquisition manager component of FIG. 1;

FIG. 3 is a flowchart of an aspect of an example of wireless communication, e.g., according to FIG. 1;

FIG. 4 is a flowchart of an aspect of another example of wireless communication, e.g., according to FIG. 1;

FIG. 5 is a diagram illustrating an example of a hardware implementation for an apparatus employing a processing system;

FIG. 6 is a block diagram conceptually illustrating an example of a telecommunications system;

FIG. 7 is block diagram conceptually illustrating an example of a Node B in communication with a UE in a telecommunications system; and

FIG. 8 is a block diagram conceptually illustrating an example of a Node B in communication with a UE in a telecommunications system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The present as aspects generally relate to efficient user equipment (UE) cell acquisition. Specifically, a UE may perform a cell acquisition process on a WCDMA cell. After a successful cell acquisition process on the WCDMA UARFCN, where the Primary Scrambling Code (PSC) is known, the UE will attempt to decode System Information Blocks (SIBs) for the WCDMA cell. The system information broadcasted on Broadcast Control Channel (BCCH) is partitioned into SIBs. Each SIB carries particular type of system information, such as PLMN info, DRX cycle coefficient (SIB1), thresholds for cell reselection (SIB3), current uplink interference level (SIB7) and other. Each SIB can be segmented and transmitted over several BCCH frames and is repeated periodically with the fixed period, called repetition count, expressed in number of system frames. The duration of one system frame is 10 milliseconds. The size of SIBs varies depending on the information they carry. For example, SIB11 carries the list of neighbors of the camping cell that the UE is supposed to measure for cell reselection purposes. Its size and number of segments will be affected by the number of neighbors of the camping cell.

However, due to poor coverage or other circumstances, the Master Information Block (MIB) may not be received successfully for the WCDMA cell; or, the MIB would be received successfully by the UE, but the UE's attempt to decode the SIBs would fail even though the UE would be aware of the Repetition cycle and Scheduling positions of the required SIBs; or while the MIB and SIB3 would be received successfully, further SIBs would not decode successfully. MIB contains the exact repetition count, number of segments, System Frame Number (SFN) of the first segment and SFN offset for the remaining segments (if any) for each of the SIBs.

As a result, the UE would have to wait for the duration of the SIB WAIT Timer and thereby hold RF resources for the WCDMA subscription to complete the SIB reception. Consequently the WCDMA subscription stays on the current cell for a longer duration even though the probability of successful camping diminishes. Furthermore, the GSM subscription will not be granted with RF resources during this period. Therefore, procedures such as Page Reception and Neighbor Cell Acquisition for the GSM subscriptions will be impacted due to the delay produced from WCDMA Acquisition. Accordingly, in some aspects, the present methods and apparatuses may provide an efficient solution, as compared to current solutions, to perform efficient SIB reading during WCDMA acquisition in multi-SIM modems.

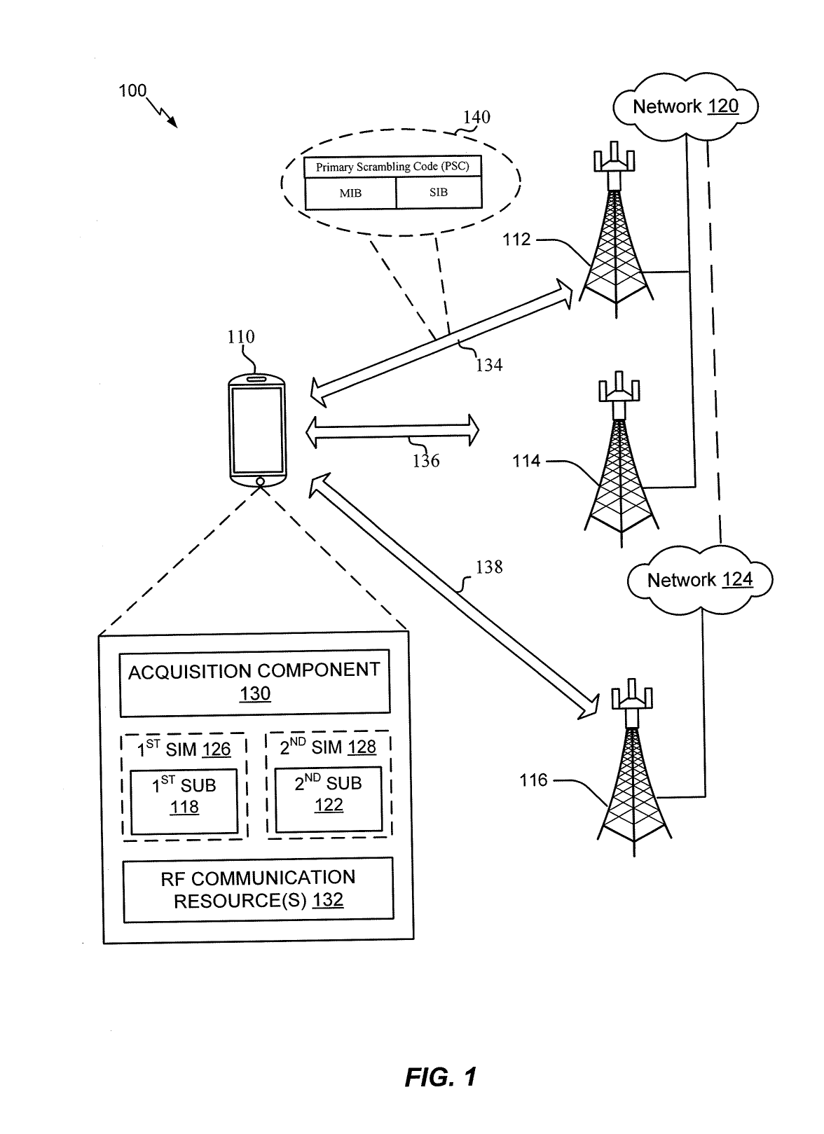

Referring to FIG. 1, in one aspect, a wireless communication system 100 includes a user equipment (UE) 110 for performing an efficient SIB reading procedure during WCDMA acquisition. For instance, UE 110 can communicate with a first base station 112, a second base station 114, and/or a third base station 116 utilizing multiple subscriptions to one or more networks. In an example, UE 110 can have a first subscription 118 related to first network 120 and second subscription 122 related to the same network, such as first network 120, or to a different network, such as second network 124. For instance, each subscription 118 and 122 may relate to a different account and/or different services on the same network or on different networks. In some aspects, each subscription 118 and 122 optionally may be maintained on a respective first subscriber identity module (SIM) 126 (1^{st} SIM 126) and a second SIM 128 (2^{nd} SIM 128). As such, in one aspect, UE 110 may be a multi-SIM, multi-standby device, such as a dual-SIM, dual standby (DSDS) device. In some aspects, UE 110 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Accordingly, UE 110 can at least communicate in first network 120 via a first base station 112 and/or via a different base station, such as second base station 114, using first subscription 118. Moreover, UE 110 can communicate in second network 124 via third base station 116 using second subscription 122. Further, first network 120 and second network 124 can use different radio access technologies (RAT) to facilitate communicating with UEs. For example, in an aspect but not limited hereto, first network 120 may be a WCDMA RAT network, while second network 124 may be a GSM RAT technology network. Additionally, first base station 112, second base station 114, and third base station 116 can each be a macrocell, picocell, femtocell, relay, Node B, mobile Node B, UE (e.g., communicating in peer-to-peer or ad-hoc mode with UE 110), or substantially any type of component that can communicate with UE 110 to provide wireless network access via a subscription at the UE 110.

In an example, UE 110 may transmit and/or receive wireless communications 134, 136, and/or 138 to and/or from the first base station 112, the second base station 114, and/or the third base station 116. Wireless communications 134 may include, but are not limited to, acquisition information 140. In such cases, UE 110 may receive acquisition information 140 from first base station 112. In some aspects, acquisition information 140 may be contained within or include information in the form of a Master Information Block (MIB), and/or a System Information Block (SIB), which may be transmitted over a Primary Common Control Physical Channel (P-CCPCH) and scrambled according to a Primary Scrambling Code (PSC). Further, acquisition information 140 may include cell (e.g., first base station 112) and/or network 120 specific parameters that are broadcast to permit UEs (e.g., UE 110) to communicate with a network (e.g., first base station 112 and/or network 120).

Further, acquisition information 140 may be signaled or communicated to UE 110 while in compressed mode (e.g., WCDMA), idle mode, FACH, or active/connected mode (e.g., DCH). For example, during idle mode, UE 110 may communicate with first base station 112 to identify a PSC used by first base station 112 for scrambling Primary Common Control Physical Channel (P-CCPCH) transmissions.

According to the present aspects, UE 110 can include acquisition component 130 configured to perform cell acquisition via a SIB reading procedure for either the first subscription 118 (1^{st} SUB 118) or the second subscription 122 (2^{nd} SUB 122). In such aspects, acquisition component 130 may receive or otherwise obtain acquisition information 140 during a SIB reading procedure. Further, during a SIB reading procedure, UE 110 may determine whether any of the one or more SIBs received with the acquisition information 140 are successfully decoded within a first time threshold during the SIB reading procedure, for example but not limited hereto, wherein the first time threshold is within a threshold number of SIB repetition occasions and is less than a SIB Wait Timer (e.g., less than 12 seconds). Subsequently acquisition component 130 may abort the SIB reading procedure for the first cell (e.g., first base station 112) when the one or more SIBs are not successfully decoded within the first time threshold.

Further, UE 110 can include RF communication resources 132 configured to transmit and/or receive the communication exchange signaling to and/or from one or more base stations or other devices in wireless communication system 100. For example, RF communication resources 132 may include, but are not limited to, one or more of a transmitter, a receiver, a transceiver, protocol stacks, transmit chain components, and receive chain components. In some aspects, RF communication resources 132 may be dedicated to operate according to the standards and procedures of a single one of first subscription 118 or second subscription 122 at any given time. For instance, although not to be construed as limiting, RF communication resources 132 may be associated with a multi-SIM, multi-standby device, such as a dual-SIM, dual standby (DSDS) device.

As a result of the operation of acquisition component 130 according to the present aspects, RF communication resources 132 may be more efficiently switched from first subscription 118 to second subscription 122 as a result of aborting the SIB reading procedure for the first cell (e.g., first base station 112) when the one or more SIBs are not successfully decoded within the first time threshold. In other words, the present apparatus and methods may speed up the acquisition procedure for first subscription 118 when SIB reading issues occur, thereby allowing the UE to move to evaluating a next cell and potentially completing the acquisition procedure more quickly, allowing RF communication resources 132 to be used sooner by second subscription 122.

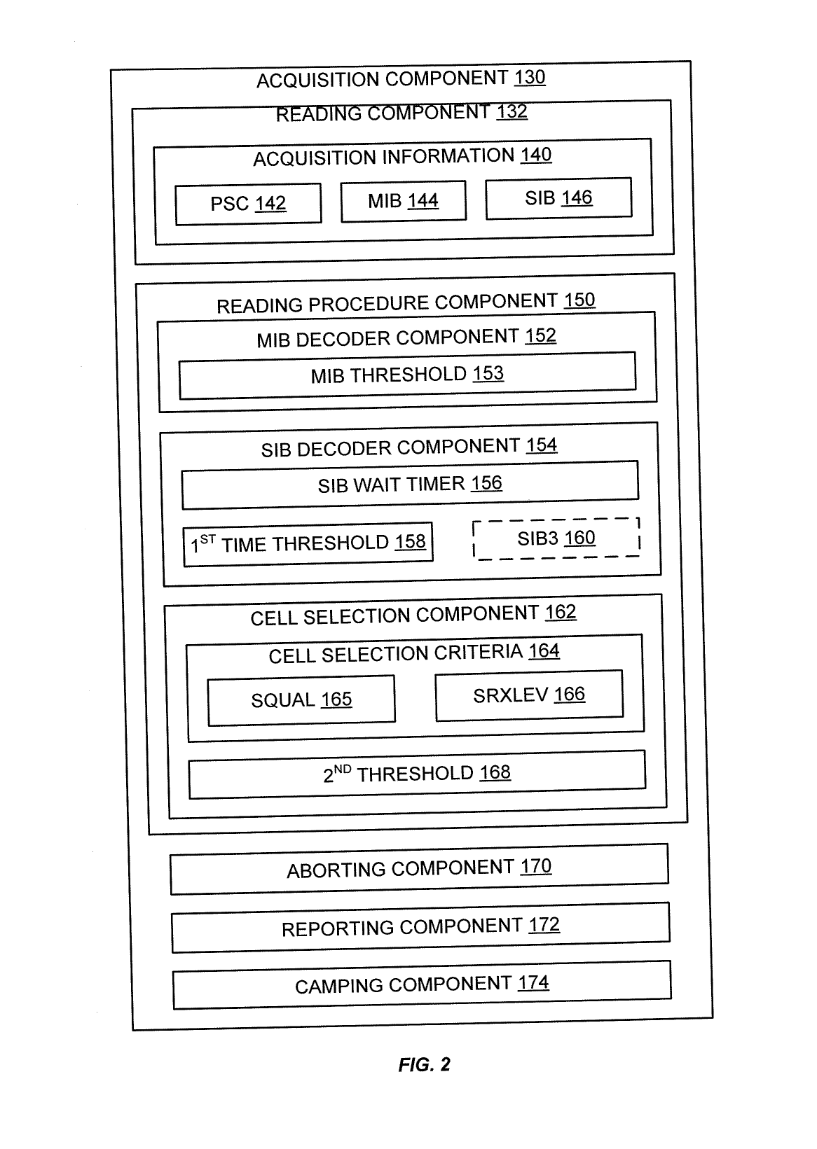

Referring to FIG. 2, an aspect of the acquisition component 130 may include various components and/or subcomponents, which may be configured to perform efficient SIB reading during WCDMA acquisition in multi-SIM modems. For instance, acquisition manager 130 may be configured to avoid unnecessary delays during the cell acquisition process. The various components/subcomponents described herein enable acquisition component 130 to achieve such improved cell reselection.

In an aspect, acquisition component 130 may include reading component 132. For instance, reading component 132 may be configured to perform a full search for known sequences transmitted over a P-SCH (Primary Synchronization CHannel) and an S-SCH (Secondary Synchronization CHannel). For example, reading component 132 may communicate with first base station 112 to scan UMTS carrier frequencies and receive acquisition information 140. In some instances, acquisition information 140 may be configured to include PSC 142, MIB 144, and SIB 146. SIB 146 may comprise one or more SIBs.

Specifically, reading component 132 may be configured to first obtain, during an idle mode, PSC 142 of a first cell of a first radio access technology (RAT) by a user equipment having a first subscription to the first RAT (e.g., 1^{st} SUB 118 of FIG. 1) and a second subscription to a second RAT (e.g., 2^{nd} SUB 122 of FIG. 1). In an example, reading component 132 may be configured to receive the S-SCH, which indicates a scrambling code group to reading component 132. Then, based on the scrambling code group, reading component 132 can determine the exact scrambling code from 8 possible codes by receiving the P-CPICH (Primary-Common Pilot CHannel) and narrowing down to the PSC (e.g., PSC 142) based on correlations.

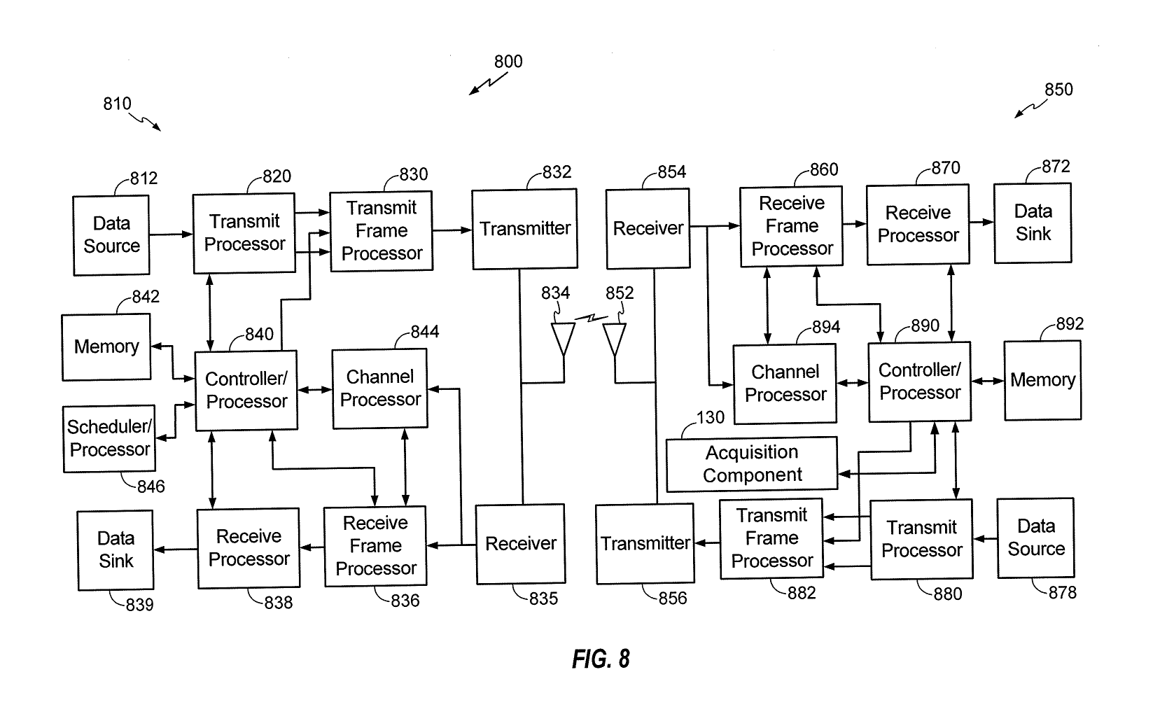

As a result, acquisition component 130 may be configured to use PSC 142 to determine MIB 144 and SIB 146, as later described. As such, reading component 132 may store acquisition information 140 in memory (such as memory 892 of FIG. 8) for later use by acquisition component 130.

Further, acquisition component 130 may include reading procedure component 150. In some instances, reading procedure component 150 may be configured to perform MIB and SIB reading procedures based on the acquisition information 140 received. For example, reading procedure component 150 may be configured to attempt decoding of MIB, perform a SIB reading procedure for one or more SIBs, and determine whether a cell selection criteria is met during the SIB reading procedure.

Reading procedure component 150 may include MIB decoder component 152. In an instance, MIB decoder component 152 may be configured to receive acquisition information 140 from reading component 132 and based at least in part on PSC 142, decode MIB 144. MIB decoder component 152 may be configured to attempt decoding MIB 144 for a threshold time value (e.g., MIB threshold 153). For example, the MIB threshold 153 may be a value based on a number of MIB occurrences (e.g., 4 MIB occurrences). Therefore, MIB threshold 153 need not just refer to a specific time duration but may also refer to a duration associated with the occurrence of a number of events, such as the occurrence of one or more MIBs and/or SIBs, for example. As such, if MIB decoder component 152 fails to decode MIB 144 within MIB threshold 153 then reading procedure component 150 may be configured to end the reading procedure for the current WCDMA cell by aborting the reading procedure, as explained below. Otherwise, if MIB decoder component 152 successfully decodes MIB 144 then information such as the exact repetition count, number of segments, System Frame Number (SFN) of the first segment and SFN offset for the remaining segments (if any) for each of the SIBs will be known. In some aspects, MIB 144 has a plurality of information including the number of segments for the SIBs (i.e., SEG_COUNT), the repetition rate of the SIBs and its segments, the position (or phase) of the first segment (i.e., SIB_POS(0)), and the offset of the subsequent segments (i.e., SIB_OFF).

In a further aspect, reading procedure component 150 may include SIB decoder component 154. In an instance, SIB decoder component 154 may be configured to determining whether any of the one or more SIBs (e.g., SIB 146) are successfully decoded within a first time threshold 158. For example, if MIB decoder component 152 indicates that MIB 144 has been successfully decoded, then SIB decoder component 154 may attempt to decode one or more SIBs (e.g., SIB 146) based at least in part on PSC 142 and MIB 144. As such, SIB decoder component 154 may be configured to determine whether any of the one or more SIBs are successfully decoded within a first time threshold 158 that corresponds to a threshold number of SIB repetition occasions. The SIB repetition occasions is based on the repetitions of System Information Block-3 (SIB3) occasions due to SIB comprising parameters for cell selection and re-selection. The parameters may include information used to compute cell selection criteria that is critical to evaluate whether the WCDMA cell is suitable to be camped on to.

Further, SIB decoder component 154 may be configured to determine whether the SIB3 160 was successfully decoded. As noted, SIB3 160 comprises parameters for cell selection and re-selection. Specifically, if there was successful decoding of SIB3 160, then cell select quality measurement quantities Qqualmin and Qrxlevmin may be known. Qqualmin corresponds to the minimum required quality level in the cell (dB). Qrxlevmin corresponds to the minimum Reference Signal Receive Power (RSRP) values measured by a UE in a cell to be able to get unrestricted coverage-based service in that cell. Qqualmin and Qrxlevmin may be used to determine whether the cell selection criteria has been met.

SIB decoder component 154 may be further configured to determine, within a threshold number of SIB repetition occasions (e.g., 1^{st} time threshold 158), whether a first duration is less than a second duration of SIB Wait Timer 156. The first duration corresponds to the total amount of time spent on decoding SIB 146. The second duration corresponds to the threshold total amount of time allowed for decoding SIB 146. Normally, the maximum value of SIB repetition occasions observed for SIB3 160 from the network is 64. As a result, in an aspect, the reading procedure waits for a threshold number, e.g., at least 5, of SIB repetition occasions of SIB3 160. It should be noted that the threshold number of SIB repetition occasions may be in a range of (X to Y, e.g., wider range), or in a range of (Q to V, narrower range). As noted, the SIB Wait Timer 156 is the period of time UE 110 is attempting to decode the SIB 146 on the P-CCPCH of the WCDMA cell. Thus, when the first duration is less than the second duration of the SIB Wait Timer 156, then SIB decoder component 154 may be configured to continue to decode SIB 146. Moreover, SIB decoder component 154 performs SIB reading procedure once again for 1^{st} time threshold and determines if one or more SIBs (e.g., SIB 144) are successfully decoded. At this instance if any one or more of the SIBs (e.g., SIB 144) have not been successfully decoded within the 1^{st} time threshold, and the first duration is greater than the second duration, then the reading procedure will be aborted, as explained below.

In another aspect, reading procedure component 150 may include cell selection component 162. In an instance, cell selection component 162 may be configured to determine whether cell selection criteria 164 is met during the reading procedure. In some aspects, cell selection criteria 164 corresponds to Squal 165, the cell selection quality value, and Srxlev 166, cell selection Rx level value. Cell selection criteria 164 is met if Srxlev>0 and Squal>0, where:

Squal=Qqualmeas−Qqualmin

Srxlev=Qrxlevmeas−Qrxlevmin−Pcompensation

As noted above, Qqualmin corresponds to the minimum required quality level in the cell, and Qrxlevmin corresponds to the minimum required Rx value in the cell. Qqualmin and Qrxlevmin are determined based on successfully decoding SIB3 160 by SIB decoder component 154. Additionally, Qqualmeas corresponds to the measured cell quality value, for example, the quality of the received signal expressed in CPICH E_{c}/N₀ (dB). Qrxlevmeas corresponds to the measured cell Rx level value, for example the received signal. Pcompensation corresponds to the maximum value between the maximum Tx power level and the maximum RF output of UE 110. Qqualmeas, Qrxlevmeas, and Pcompensation may be measured and/or received by UE 110 and/or acquisition component 130, during an idle mode, when communicating with first base station 112 to scan UMTS carrier frequencies and receive acquisition information 140.

Cell selection component 162 may be configured to compute Squal 165 and Srxlev 166 based on the formulas stated above. As a result, cell selection component 162 may be configured to determine if both Squal 165 and Srxlev 166 are greater than zero (e.g., Srxlev>0 and Squal>0). If it is determined that Squal 165 and Srxlev 166 are greater than zero, then cell selection component 162 may be configured to determine that cell selection criteria 164 is met.

Additionally, cell selection component 162 may be configured to determine if cell selection criteria 164 has been met for a 2^{nd} threshold 168. In some instances, 2^{nd} threshold corresponds to a threshold number of SIB repetition occasions of unread SIBs from the one or more SIBs (e.g., SIB 146). The threshold number of SIB repetition occasions of unread SIBs can be calculated, for example, as twice the maximum of SIB repetitions of unread SIBs. If cell selection component 162 determines that cell selection criteria 164 has not been met for a 2^{nd} threshold 168 then the reading procedure will abort. However, if cell selection component 162 determines that cell selection criteria 164 has been met for a 2^{nd} threshold 168 then the reading procedure results may be reported and the camping on the WCDMA cell may occur. Moreover, cell selection component 162 may be configured to determine whether the cell selection criteria check has been performed for all of the one or more SIBs (e.g., SIB 146) that were successfully decoded. If so, then the reading procedure results may be reported and the camping on the WCDMA cell may occur. If not, then cell selection component 162 may be configured to determine whether cell selection criteria 164 is met during the reading procedure for the remaining unread SIBs.

Further, acquisition component 130 may include aborting component 170. In an instance, aborting component 170 may be configured to abort the reading procedure based on indications received from MIB decoder component 152, SIB decoder component 154, and/or cell selection component 162. For example, aborting component 170 may be configured to abort the reading procedure on the W-CDMA cell when the MIB decoder component 152 fails to decode MIB 144 within MIB threshold 153. In another example, aborting component 170 may be configured to abort the reading procedure on the W-CDMA cell when the SIB decoder component 154 fails to decode SIB 146 within the 1^{st} time threshold 158 and/or cell selection component 162 determines that cell selection criteria 162 have not been met for a 2^{nd} threshold 168.

As a result, aborting component 170 may be configured to abort the reading procedure for the current cell (e.g., first base station 112 of FIG. 1) and proceed to the next cell (e.g., second base station 114 of FIG. 1) for the network (e.g., network 120 of FIG. 1) to attempt cell acquisition for the next cell. As such, by performing an early (e.g., relative to current standards and/or a SIB Wait Timer) aborting of the reading procedure for the respective cell, UE 110 and/or acquisition component 130 allow the acquisition procedure to move to considering a next cell, and may allow earlier transitioning of RF communication resources to another subscription. In some instances, attempting the SIB reading procedure on the next cell further comprises performing the SIB reading procedure for a second cell for one or more SIBs of the second cell; and performing the SIB reading procedure for a third cell for one or more SIBs of the third cell in response to aborting the SIB reading procedure for the second cell when the one or more SIBs of the second cell are not successfully decoded with the first time threshold.

Additionally, acquisition component 130 may include reporting component 172. In an instance, reporting component 172 may be configured to report the results of the reading procedure based on the information received from cell selection component 162. For example, reporting component 172 may be configured to report the results of the reading procedure when all the SIB occasions have been consecutively met for a threshold number of SIB repetition occasions of unread SIBs of the one or more SIBs.

Acquisition component 130 may include camping component 174. In an instance, camping component 174 may be configured to include camp on the WCDMA cell (e.g., first base station 112 of FIG. 1). For example, camping component 174 may be configured to camp on first base station 112 (FIG. 1) when all the SIB occasions have been consecutively met for a threshold number of SIB repetition occasions of unread SIBs of the one or more SIBs.

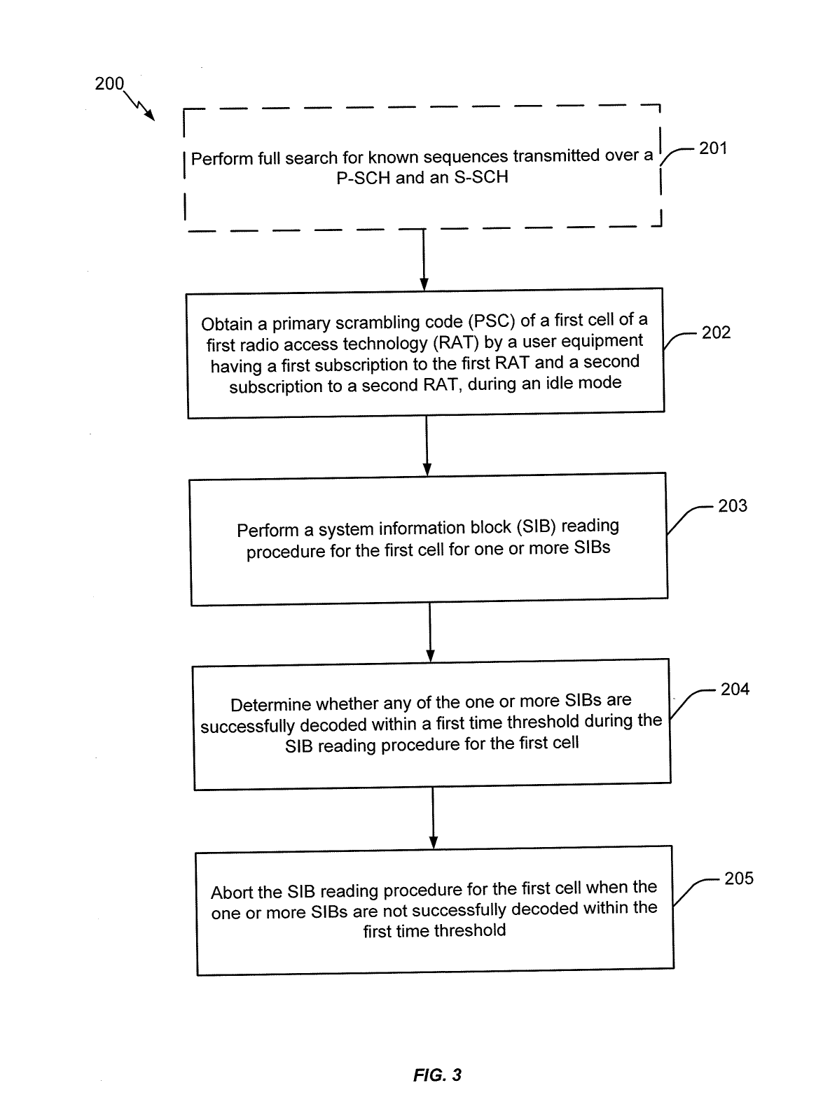

Referring to FIG. 3, in operation, a UE such as UE 110 (FIG. 1) may perform one aspect of a method 200 for efficient SIB reading during WCDMA acquisition in multi-SIM modems. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein. As described in further detail below, the method 200 provides a process tailored to minimize or at least reduce the amount of delay due to SIB reception failures during cell acquisition for UE 110 (FIG. 1).

In an aspect, at block 201, method 200 may optionally include performing a full search for known sequences transmitted over a P-SCH and a S-SCH. For example, as described herein, acquisition component 130 and/or reading component 132 (FIG. 2) may communicate with first base station 112 to scan UMTS carrier frequencies. For example, acquisition component 130 and/or reading component 132 execute hardware and/or computer-readable instructions to look for known sequences transmitted over a P-SCH (Primary Synchronization CHannel) and an S-SCH (Secondary Synchronization CHannel). Acquisition component 130 and/or reading component 132 performs correlations between received signals and known P-SCH and S-SCH sequences, and a highest correlation or strongest correlation peak is chosen in order to obtain slot and frame timing. For example, acquisition component 130 and/or reading component 132 may communicate with first base station 112 to scan UMTS carrier frequencies and receive acquisition information 140. In some instances, acquisition information 140 may be configured to include PSC 142, MIB 144, and SIB 146. SIB 146 may comprise one or more SIBs.

Moreover, at block 202, method 200 may include obtaining, during an idle mode, a primary scrambling code of a first cell of a first radio access technology (RAT) by a user equipment having a first subscription to the first RAT and a second subscription to a second RAT. For instance, as described herein, acquisition component 130 and/or reading component 132 (FIG. 2) may execute hardware and/or computer-readable instructions to receive the S-SCH, which indicates a scrambling code group to acquisition component 130 and/or reading component 132. Then, based on the scrambling code group, acquisition component 130 and/or reading component 132 can determine the exact scrambling code from 8 possible codes by receiving the P-CPICH (Primary-Common PIlot CHannel) and narrowing down to the PSC based on correlations. As a result, acquisition component 130 may be configured to use PSC 142 to determine MIB 144 and SIB 146, as later described. As such, reading component 132 may store acquisition information 140 in memory (such as memory 892 of FIG. 8) for later use by acquisition component 130.

In addition, at block 203, method 200 may include performing a system information block (SIB) reading procedure for the first cell for one or more SIBs. For example, as described herein, acquisition component 130 and/or reading procedure component 150 (FIG. 2) may execute hardware and/or computer-readable instructions to determining whether any of the one or more SIBs (e.g., SIB 146) are successfully decoded within a first time threshold 158. For example, SIB decoder component 154 may attempt to decode one or more SIBs (e.g., SIB 146) based at least in part on PSC 142 and MIB 144.

At block 204, method 200 may include determining whether any of the one or more SIBs are successfully decoded within a first time threshold during the SIB reading procedure for the first cell. For instance, as described herein, acquisition component 130 and/or reading procedure component 150 (FIG. 2) may execute hardware and/or computer-readable instructions to determine whether any of the one or more SIBs (e.g., SIB 146) are successfully decoded within a first time threshold 158 that corresponds to a threshold number of SIB repetition occasions. The SIB repetition occasions is based on the repetitions of System Information Block-3 (SIB3) occasions due to SIB comprising parameters for cell selection and re-selection. The parameters may include information used to compute cell selection criteria that is critical to evaluate whether the WCDMA cell is suitable to be camped on to.

At block 205, method 200 may include aborting the SIB reading procedure for the first cell when the one or more SIBs are not successfully decoded within the first time threshold. For example, as described herein, acquisition component 130 and/or aborting component 170 (FIG. 2) may abort the SIB reading procedure it is determined that any one or more of the SIBs have not been successfully decoded within the first time threshold (based on executing the actions of block 204). As such, by performing an early (e.g., relative to current standards and/or a SIB Wait Timer 156) aborting of the SIB reading procedure for the respective cell, acquisition component 130 and/or aborting component 170 allow the acquisition procedure to move to considering a next cell, and may allow earlier transitioning of RF communication resources to another subscription.

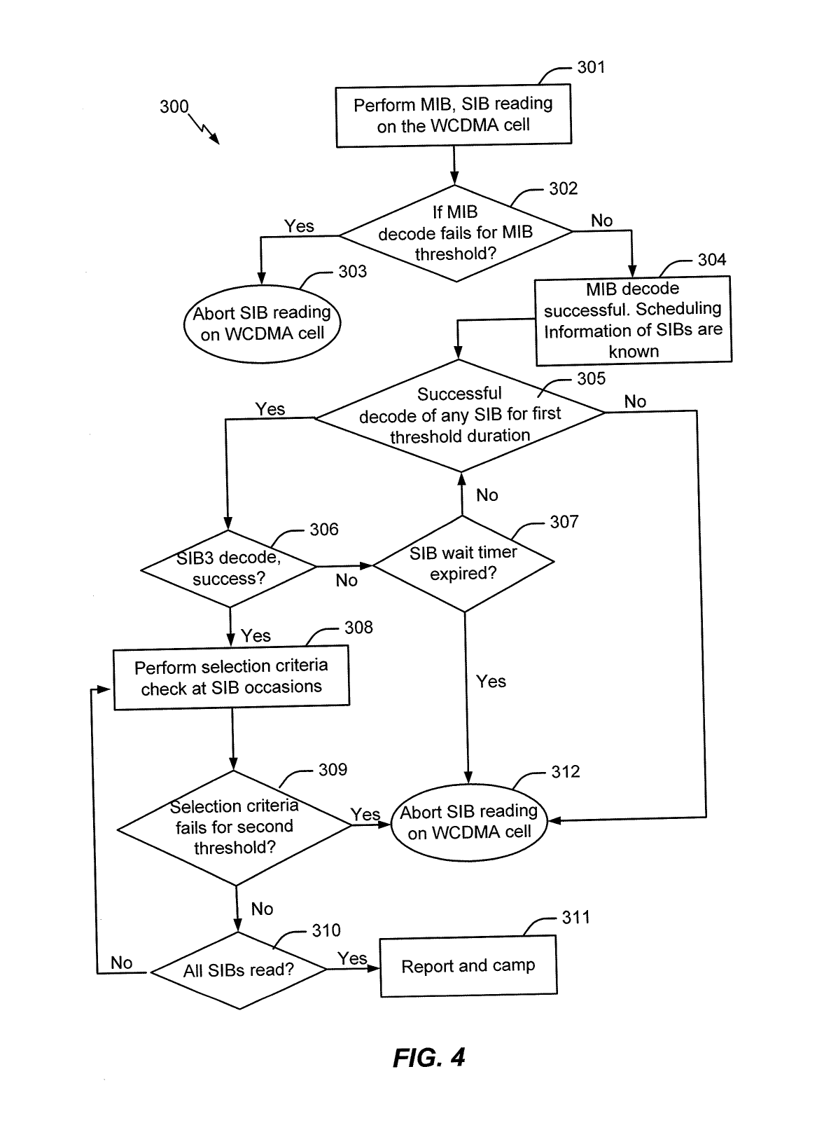

Referring to FIG. 4, in an example of a more detailed aspect of method 200 of FIG. 2, method 300 includes example actions executed in efficient SIB reading during WCDMA acquisition in a multi-SIM, multi-service (e.g., WCDMA and GSM) UE according to one aspect of the present disclosure. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein. As described in further detail below, the method 300 provides a process tailored to minimize or at least reduce the amount of delay due to SIB reception failures during cell acquisition for UE 110 (FIG. 1).

At block 301, method 300 may include performing MIB and SIB readings on the WCDMA cell. For example, as described herein (e.g., see the above description of FIG. 2), acquisition component 130 and/or reading component 132 (FIG. 2) may execute hardware and/or computer-readable instructions to look for known sequences transmitted over a P-SCH (Primary Synchronization CHannel) and an S-SCH (Secondary Synchronization CHannel). Acquisition component 130 and/or reading component 132 performs correlations between received signals and known P-SCH and S-SCH sequences, and a highest correlation or strongest correlation peak is chosen in order to obtain slot and frame timing. For example, acquisition component 130 and/or reading component 132 may communicate with first base station 112 to scan UMTS carrier frequencies and receive acquisition information 140. In some instances, acquisition information 140 may be configured to include PSC 142, MIB 144, and SIB 146. SIB 146 may comprise one or more SIBs.

Further, at block 302, method 300 may include determining if the MIB decode fails within a MIB time threshold. For instance, as described herein, acquisition component 130 and/or MIB decoder component 152 (FIG. 2) may execute hardware and/or computer-readable instructions to determine if the decode of the MIB 144 fails for MIB threshold 153 (e.g., a value 4 MIB occurrences). In an instance, acquisition component 130 and/or MIB decoder component 152 may be configured to receive acquisition information 140 from reading component 132 and based at least in part on PSC 142, decode MIB 144. MIB decoder component 152 may be configured to attempt decoding MIB 144 for MIB threshold 153. As such, if MIB decoder component 152 fails to decode MIB 144 within MIB threshold 153 then reading procedure component 150 may be configured to end the reading procedure for the current WCDMA cell by aborting the reading procedure, as explained below. Otherwise, if MIB decoder component 152 successfully decodes MIB 144 then information such as the exact repetition count, number of segments, System Frame Number (SFN) of the first segment and SFN offset for the remaining segments (if any) for each of the SIBs will be known. In some aspects, MIB 144 has a plurality of information including the number of segments for the SIBs (i.e., SEG_COUNT), the repetition rate of the SIBs and its segments, the position (or phase) of the first segment (i.e., SIB_POS(0)), and the offset of the subsequent segments (i.e., SIB_OFF).

At block 303, method 300 may include aborting the SIB reading procedure on the WCDMA cell when the MIB decode fails within the MIB time threshold. For example, as described herein, acquisition component 130 and/or aborting component 170 may abort the reading procedure on the current WCDMA cell if it is determined that the MIB decoder component 152 fails to decode MIB 144 within MIB threshold 153. As a result, if acquisition component 130 and/or MIB decoder component 152 cannot decode the above information from MIB 144 then the scheduling information and repetition information for the SIBs (e.g., SIB 146) are not known, and so, the acquisition component 130 and/or aborting component 170 will abort the reading procedure.

At block 304, method 300 may include performing a SIB reading procedure for one or more SIBs if the MIB decode was successful within the MIB time threshold. For example, as described herein, acquisition component 130 and/or SIB decoder component 154 begins the reading procedure after successful decode of MIB 144. As described herein, acquisition component 130 and/or SIB decoder component 154 (FIG. 2) may execute hardware and/or computer-readable instructions to determine whether any of the one or more SIBs (e.g., SIB 146) are successfully decoded within a first time threshold 158. For example, SIB decoder component 154 may attempt to decode one or more SIBs (e.g., SIB 146) based at least in part on PSC 142 and MIB 144.

At block 305, method 300 may include determining whether any of the one or more SIBs are successfully decoded within a first time threshold during the SIB reading procedure. For example, as described herein, acquisition component 130 and/or SIB decoder component 154 determines if any of the one or more SIBs (e.g., SIB 146) received as part of acquisition information 140 were successfully decoded within a first time threshold 158 (e.g., 4 seconds). For instance, acquisition component 130 and/or SIB decoder component 154 (FIG. 2) may execute hardware and/or computer-readable instructions to determine whether any of the one or more SIBs (e.g., SIB 146) are successfully decoded within a first time threshold 158 that corresponds to a threshold number of SIB repetition occasions. The SIB repetition occasions are based on the repetitions of System Information Block-3 (SIB3) occasions due to SIB comprising parameters for cell selection and re-selection. The parameters may include information used to compute cell selection criteria that is critical to evaluate whether the WCDMA cell is suitable to be camped on to. If at block 305, the any of the one or more SIBs (e.g., SIB 146) were not successfully decoded within a first time threshold 158, then method 300 may proceed to block 312.

At block 312, method 300 may include aborting the SIB reading procedure on the WCDMA cell. For example, as described herein, acquisition component 130 and/or aborting component 170 may abort the reading procedure for the current cell (e.g., first base station 112) and proceed to the next cell (e.g., second base station 114) for the network (e.g., network 120) to attempt cell acquisition for the next cell. In some aspects, UE acquisition component 130 and/or aborting component 170 (FIG. 2) may abort the reading procedure it is determined that any of the one or more SIBs (e.g., SIB 146) have not been successfully decoded within the first time threshold 158 (based on executing the actions of block 305), and/or that the cell selection criteria 164 has failed for a second threshold 168 (based on executing the actions of block 309). As such, by performing an early (e.g., relative to current standards and/or a SIB Wait Timer 156) aborting of the reading procedure for the respective cell, acquisition component 130 and/or aborting component 170 allow the reading procedure to move to considering a next cell, and may allow earlier transitioning of RF communication resources to another subscription.

However, if at block 305, the one or more SIBs are successfully decoded, then method 300 proceeds to block 306. At block 306, method 300 may include determining whether SIB3 was successfully decoded. For example, as described herein, acquisition component 130 and/or aborting component 170 determines if any of the successfully decoded SIBs were SIB3 160. Specifically, if there was successful decoding of SIB3 160, then cell select quality measurement quantities Qqualmin and Qrxlevmin will be known. Qqualmin corresponds to the minimum required quality level in the cell (dB). Qrxlevmin corresponds to the minimum Reference Signal Receive Power (RSRP) values measured by a UE in a cell to be able to get unrestricted coverage-based service in that cell. Qqualmin and Qrxlevmin may be used to determine whether the cell selection criteria has been met. As such, to provide additional efficiencies for the present aspects, method 300 may determine whether or not SIB3 160 has been decoded in order to determine whether or not to initiate a second check of the cell with respect to whether or not to abort the reading procedure. If at block 306, the SIB3 160 is not successfully decoded, then method 300 proceeds to block 307.

At block 307, the method 300 may include determining within a threshold number of SIB repetition occasions whether a first duration is less than a second duration of a SIB Wait Timer. For example, as described herein, acquisition component 130 and/or SIB decoder component 154 determines if the first duration is less than a second duration of a SIB Wait Timer 156 is within threshold number of SIB repetition occasions (e.g., 1^{st} time threshold 158). The first duration corresponds to the total amount of time spent on decoding SIB 146. The second duration corresponds to the threshold total amount of time allowed for decoding SIB 146. Normally, the maximum value of SIB repetition occasions observed for SIB3 160 from the network is 64. As a result, in an aspect, the reading procedure waits for a threshold number, e.g., at least 5, of SIB repetition occasions of SIB3 160. It should be noted that the threshold number of SIB repetition occasions may be in a range of (X to Y, e.g., wider range), or in a range of (Q to V, narrower range). As noted, the SIB Wait Timer 156 is the period of time UE 110 is attempting to decode the SIB 146 on the P-CCPCH of the WCDMA cell. If at block 307, the first duration is less than the second duration of the SIB Wait Timer 156, then method 300 returns to block 305. Further, at block 305, the method 300 performs SIB reading procedure once again for 1^{st} time threshold 158 and determines if one or more SIBs (e.g., SIB 144) are successfully decoded. At this instance if any one or more of the SIBs (e.g., SIB 144) have not been successfully decoded within the 1^{st} time threshold, and the first duration is greater than the second duration, then the method 300 will proceed to block 311 and abort the SIB reading procedure. Thus, if at block 307, the first duration is greater than the second duration of the SIB Wait Timer 156, then method 300 proceeds to block 311, and aborts the SIB reading procedure.

Further, if at block 306, the SIB3 is successfully decoded, then method 300 proceeds to block 308. At block 308, method 300 may include performing selection criteria check for the SIB occasions. For example, as described herein, acquisition component 130 and/or cell selection component 162 may perform cell selection criteria check at every SIB repetition occasion. In an instance, acquisition component 130 and/or cell selection component 162 may be configured to determine whether cell selection criteria 164 is met during the reading procedure. In some aspects, cell selection criteria 164 corresponds to Squal 165 and Srxlev 166. Cell selection criteria 164 is met if Srxlev>0 and Squal>0, where:

Squal=Qqualmeas−Qqualmin

Srxlev=Qrxlevmeas−Qrxlevmin−Pcompensation

As noted, Qqualmin corresponds to the minimum required quality level in the cell, and Qrxlevmin corresponds to the minimum required Rx value in the cell. Qqualmin and Qrxlevmin are determined based on successfully decoding SIB3 160 by SIB decoder component 154. Additionally, Qqualmeas corresponds to the measured cell quality value, for example, the quality of the received signal expressed in CPICH E_{c}/N₀ (dB). Qrxlevmeas corresponds to the measured cell Rx level value, for example the received signal. Pcompensation corresponds to the maximum value between the maximum Tx power level and the maximum RF output of UE 110. Qqualmeas, Qrxlevmeas, and Pcompensation may be measured and/or received by acquisition component 130 and/or reading component 132, during an idle mode, when communicating with first base station 112 to scan UMTS carrier frequencies and receive acquisition information 140.

Further, at block 306, acquisition component 130 and/or cell selection component 162 may be configured to compute Squal 165 and Srxlev 166 based on the formulas stated above. As a result, cell selection component 162 may be configured to determine if both Squal 165 and Srxlev 166 are greater than zero (e.g., Srxlev>0 and Squal>0). If it is determined that Squal 165 and Srxlev 166 are greater than zero, then cell selection component 162 may be configured to determine that cell selection criteria 164 is met.

At block 309, the method may include determining if the cell selection criteria fails for a second threshold. For example, as described herein, acquisition component 130 and/or cell selection component 162 determines whether cell selection criteria 164 has been met for a 2^{nd} threshold 168. In some instances, 2^{nd} threshold 168 corresponds to a threshold number of SIB repetition occasions of unread SIBs from the one or more SIBs (e.g., SIB 146). The threshold number of SIB repetition occasions of unread SIBs can be calculated, for example, as twice the maximum of SIB repetitions of unread SIBs. If at block 309, the cell selection criteria 164 fails for the 2^{nd} threshold 168, then method 300 proceeds to block 312. As previously noted, at block 312, method 300 may include aborting the SIB reading procedure on the WCDMA cell.

However, if at block 309, the cell selection criteria 164 succeeds for the 2^{nd} threshold 168, then method 300 proceeds to block 310. At block 310, method 300 may include determining whether the cell selection criteria check has been performed for all of the one or more SIBs (e.g., SIB 146) that were successfully decoded. For example, as described herein, acquisition component 130 and/or cell selection component 162 may determine whether the cell selection criteria check has been performed for all of the one or more SIBs (e.g., SIB 146) that were successfully decoded.

If at block 310, all the cell selection criteria check has not been performed for all of the one or more SIBs (e.g., SIB 146) that were successfully decoded, then method 300 returns to block 308. However, if at block 310, all the cell selection criteria check has been performed for all of the one or more SIBs (e.g., SIB 146) that were successfully decoded, then method 300 proceeds to block 311.

At block 311, method 300 may include reporting the results of the SIB reading procedure and camping on the WCDMA cell. For example, acquisition component 130 and/or camping component 174 may execute hardware and/or computer-readable instructions to camp on first base station 112 (FIG. 1) when all the SIB occasions have been consecutively met for a threshold number of SIB repetition occasions of unread SIBs of the one or more SIBs (e.g., SIB 146). Additionally, acquisition component 130 and/or reporting component 172 may execute hardware and/or computer-readable instructions to report the results of the reading procedure when all the SIB occasions have been consecutively met for a threshold number of SIB repetition occasions of unread SIBs of the one or more SIBs (e.g., SIB 146).

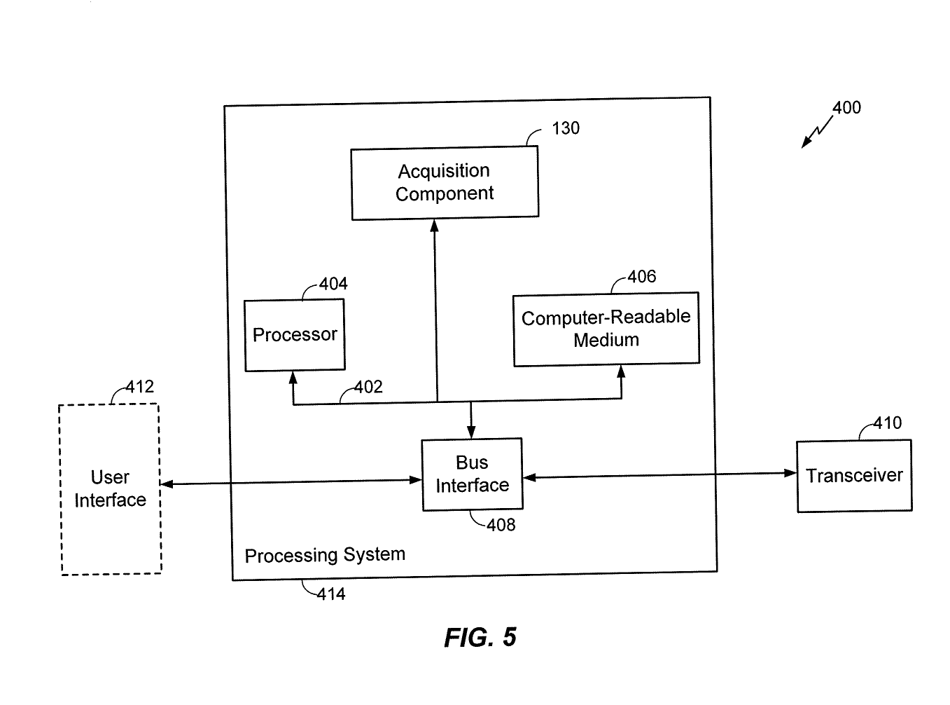

FIG. 5 is a conceptual diagram illustrating an example of a hardware implementation for an apparatus 400 employing a processing system 414, where apparatus 400 may be UE 110 or may be included with UE 110, and where apparatus 400 is configured with acquisition component 130 for performing the actions described herein. In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, acquisition component 416, and computer-readable media, represented generally by the computer-readable medium 406. The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described infra for any particular apparatus. The computer-readable medium 406 may also be used for storing data that is manipulated by the processor 404 when executing software. Further, the acquisition component 130 is responsible for implementing the SIB reading procedure during cell acquisition. The acquisition component 130 may be a part of processor 404 and/or computer-readable medium 406.

The various concepts presented throughout this disclosure may be implemented across a broad variety of telecommunication systems, network architectures, and communication standards.

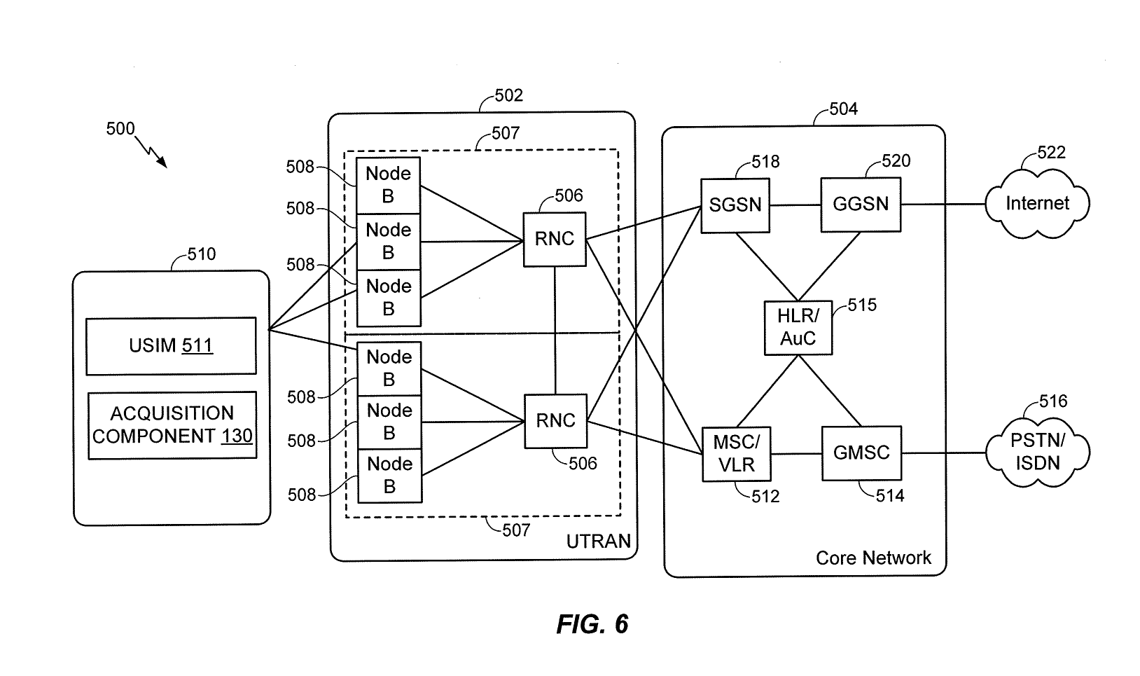

By way of example and without limitation, the aspects of the present disclosure illustrated in FIG. 6 are presented with reference to a UMTS system 500 employing a W-CDMA air interface. In this case, user equipment 510 may be the same as or similar to UE 110 of FIG. 1, and may include acquisition component 130 as described herein. A UMTS network includes three interacting domains: a Core Network (CN) 504, a UMTS Terrestrial Radio Access Network (UTRAN) 502, and User Equipment (UE) 510. In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508 may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 507; however, the RNSs 507 may include any number of wireless Node Bs. The Node Bs 508 provide wireless access points to a CN 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. For illustrative purposes, one UE 510 is shown in communication with a number of the Node Bs 508. The DL, also called the forward link, refers to the communication link from a Node B 508 to a UE 510, and the UL, also called the reverse link, refers to the communication link from a UE 510 to a Node B 508.

The CN 504 interfaces with one or more access networks, such as the UTRAN 502. As shown, the CN 504 is a GSM core network. However, as those skilled in the art will recognize, the various concepts presented throughout this disclosure may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 508 and a UE 510. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 510 provides feedback to the node B 508 over the HS-DPCCH to indicate whether it correctly decoded a packet on the downlink.

HS-DPCCH further includes feedback signaling from the UE 510 to assist the node B 508 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 508 and/or the UE 510 may have multiple antennas supporting MIMO technology. The use of MIMO technology enables the node B 508 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 510 to increase the data rate or to multiple UEs 510 to increase the overall system capacity. This is achieved by spatially precoding each data stream and then transmitting each spatially precoded stream through a different transmit antenna on the downlink. The spatially precoded data streams arrive at the UE(s) 510 with different spatial signatures, which enables each of the UE(s) 510 to recover the one or more the data streams destined for that UE 510. On the uplink, each UE 510 may transmit one or more spatially precoded data streams, which enables the node B 508 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

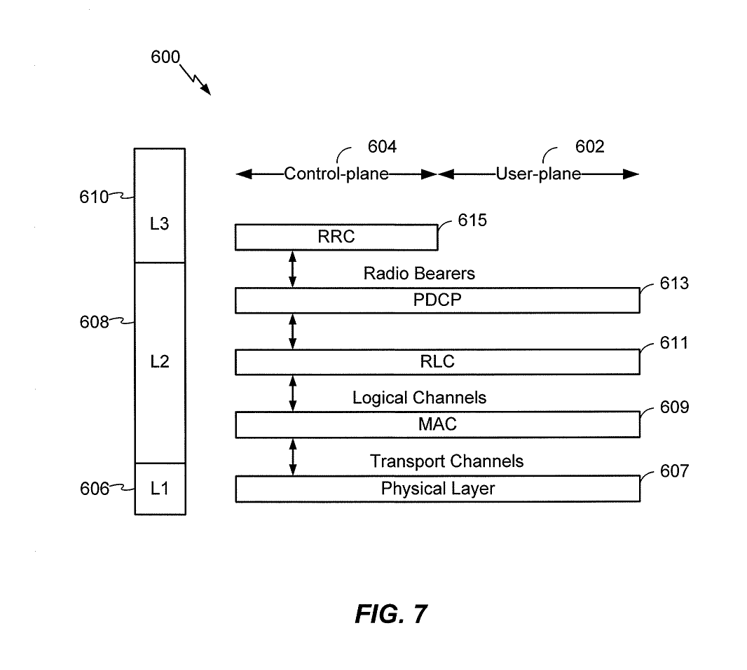

The radio protocol architecture may take on various forms depending on the particular application. An example for an HSPA system will now be presented with reference to FIG. 7.

Referring to FIG. 7 an example radio protocol architecture 600 relates to the user plane 602 and the control plane 604 of a user equipment (UE) or node B/base station. For example, architecture 600 may be included in a UE such as UE 110 (FIG. 1) configured to execute acquisition component 130. The radio protocol architecture 600 for the UE and node B is shown with three layers: Layer 1 606, Layer 2 608, and Layer 3 610. Layer 1 606 is the lowest lower and implements various physical layer signal processing functions. As such, Layer 1 606 includes the physical layer 607. Layer 2 (L2 layer) 608 is above the physical layer 607 and is responsible for the link between the UE and node B over the physical layer 607. Layer 3 (L3 layer) 610 includes a radio resource control (RRC) sublayer 615. The RRC sublayer 615 handles the control plane signaling of Layer 3 between the UE and the UTRAN.

In the user plane, the L2 layer 608 includes a media access control (MAC) sublayer 609, a radio link control (RLC) sublayer 611, and a packet data convergence protocol (PDCP) 613 sublayer, which are terminated at the node B on the network side. Although not shown, the UE may have several upper layers above the L2 layer 608 including a network layer (e.g., IP layer) that is terminated at a PDN gateway on the network side, and an application layer that is terminated at the other end of the connection (e.g., far end UE, server, etc.).

The PDCP sublayer 613 provides multiplexing between different radio bearers and logical channels. The PDCP sublayer 613 also provides header compression for upper layer data packets to reduce radio transmission overhead, security by ciphering the data packets, and handover support for UEs between node Bs. The RLC sublayer 611 provides segmentation and reassembly of upper layer data packets, retransmission of lost data packets, and reordering of data packets to compensate for out-of-order reception due to hybrid automatic repeat request (HARQ). The MAC sublayer 609 provides multiplexing between logical and transport channels. The MAC sublayer 609 is also responsible for allocating the various radio resources (e.g., resource blocks) in one cell among the UEs. The MAC sublayer 609 is also responsible for HARQ operations.

FIG. 8 is a block diagram of a Node B 810 in communication with a UE 850, where the Node B 810 may be the Node B 508 in FIG. 6 (or one of the base stations 112, 114, and/or 116 in FIG. 1), and the UE 850 may be the UE 110 in FIG. 1, including the acquisition component 130 for performing the actions described herein. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

Several aspects of a telecommunications system has been presented with reference to a W-CDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §212, sixth paragraph, unless the element is expressly recited using the phrase “means for” or, in the case of a method claim, the element is recited using the phrase “step for.”

What is claimed is:

1. A method of cell acquisition, comprising:
obtaining, during an idle mode, a primary scrambling code (PSC) of a first cell of a first radio access technology (RAT) by a user equipment having a first subscription to the first RAT and a second subscription to a second RAT;
performing a system information block (SIB) reading procedure for the first cell for one or more SIBs;
determining whether any of the one or more SIBs are successfully decoded within a first time threshold during the SIB reading procedure for the first cell; and
aborting the SIB reading procedure for the first cell when the one or more SIBs are not successfully decoded within the first time threshold.

2. The method of claim 1, wherein the determining further comprises determining within a threshold number of SIB repetition occasions, and wherein the aborting further comprises aborting when any of the one or more SIBs are not successfully decoded within the threshold number of SIB repetition occasions.

3. The method of claim 2, wherein the determining within the threshold number of SIB repetition occasions further comprises determining if a first duration is less than a second duration of a SIB Wait Timer.

4. The method of claim 1, wherein the determining whether any of the one or more SIBs are successfully decoded within the first time threshold further comprises determining whether any of the one or more successfully decoded SIBs are a successfully decoded System Information Block-3 (SIB3).

5. The method of claim 4, further comprising:
determining whether a cell selection criteria is met during the SIB reading procedure,
wherein aborting the SIB reading procedure for the first cell further depends on when the cell selection criteria is not met.

6. The method of claim 5, wherein determining whether a cell selection criteria is met during the SIB reading procedure for the first cell further comprises determining whether the cell selection criteria is met when the SIB3 is successfully decoded.

7. The method of claim 5, wherein determining whether the cell selection criteria is met further comprises:
comparing the cell selection criteria to a criteria threshold for all SIB repetition occasions of the one or more SIBs;
determining whether the cell selection criteria is greater than the criteria threshold for a threshold number of SIB repetition occasions of unread SIBs from the one or more SIBs,
wherein the aborting further comprises aborting when the cell selection criteria is less than the criteria threshold for the threshold number of SIB repetition occasions.

8. The method of claim 7, further comprising calculating the threshold number of SIB repetition occasions based on twice a maximum of the SIB repetition occasions of one or more unread SIBs.

9. The method of claim 4, wherein determining whether any of the one or more successfully decoded SIBs are the successfully decoded SIB3 further comprises at least one or both of aborting the SIB reading procedure for the first cell when the SIB3 is not successfully decoded and a first duration is greater than a second duration of a SIB Wait Timer, and returning to the step of determining whether any of the one or more SIBs are successfully decoded when the SIB3 is not successfully decoded and a first duration is less than a second duration of a SIB wait timer.

10. The method of claim 1, wherein aborting the SIB reading procedure for the first cell further comprises:
attempting the SIB reading procedure on a next cell, wherein attempting the SIB reading procedure on the next cell further comprises:
performing the SIB reading procedure for a second cell for one or more SIBs of the second cell; and
performing the SIB reading procedure for a third cell for one or more SIBs of the third cell in response to aborting the SIB reading procedure for the second cell when the one or more SIBs of the second cell are not successfully decoded with the first time threshold; or
initiating a tune away to the second RAT.

11. A computer program product, comprising:
a computer-readable medium comprising code for:
at least one instruction executable to cause a computer to obtain, during an idle mode, a primary scrambling code (PSC) of a first cell of a first radio access technology (RAT) by a user equipment having a first subscription to the first RAT and a second subscription to a second RAT;
at least one instruction executable to cause a computer to perform a system information block (SIB) reading procedure for the first cell for one or more SIBs;
at least one instruction executable to cause a computer to determine whether any of the one or more SIBs are successfully decoded within a first time threshold during the SIB reading procedure for the first cell; and
at least one instruction executable to cause a computer to abort the SIB reading procedure for the first cell when the one or more SIBs are not successfully decoded within the first time threshold.

12. An apparatus for communication, comprising:
a memory storing executable instructions; and
a processor in communication with the memory, wherein the processor is configured to execute the instructions to:
obtain, during an idle mode, a primary scrambling code (PSC) of a first cell of a first radio access technology (RAT) by a user equipment having a first subscription to the first RAT and a second subscription to a second RAT;
perform a system information block (SIB) reading procedure for one or more SIBs;
determine whether any of the one or more SIBs are successfully decoded within a first time threshold during the SIB reading procedure; and
abort the SIB reading procedure for the first cell when the one or more SIBs are not successfully decoded within the first time threshold.

13. The apparatus of claim 12, wherein the determining further comprises determining within a threshold number of SIB repetition occasions, and wherein the aborting further comprises aborting when any of the one or more SIBs are not successfully decoded within the threshold number of SIB repetition occasions.

14. The apparatus of claim 13, wherein the determining within the threshold number of SIB repetition occasions further comprises determining if a first duration is less than a second duration of a SIB Wait Timer.

15. The apparatus of claim 12, wherein the determining whether any of the one or more SIBs are successfully decoded within the first time threshold further comprises determining whether any of the one or more successfully decoded SIBs are a successfully decoded System Information Block-3 (SIB3).

16. The apparatus of claim 15, wherein the processor is further configured to execute the instructions to:
determine whether a cell selection criteria is met during the SIB reading procedure,
wherein aborting the SIB reading procedure for the first cell further depends on when the cell selection criteria is not met.

17. The apparatus of claim 16, wherein determining whether a cell selection criteria is met during the SIB reading procedure for the first cell further comprises determining whether the cell selection criteria is met when the SIB3 is successfully decoded.

18. The apparatus of claim 16, wherein determining whether the cell selection criteria is met further comprises:
comparing the cell selection criteria to a criteria threshold for all SIB repetition occasions of the one or more SIBs;
determining whether the cell selection criteria is greater than the criteria threshold for a threshold number of SIB repetition occasions of unread SIBs from the one or more SIBs, wherein the threshold number of SIB repetition occasions are calculated based on twice a maximum of the SIB repetition occasions of one or more unread SIBs, and wherein the aborting further comprises aborting when the cell selection criteria is less than the criteria threshold for the threshold number of SIB repetition occasions.

19. The apparatus of claim 15, wherein determining whether any of the one or more successfully decoded SIBs are the successfully decoded SIB3 further comprises at least one or both of aborting the SIB reading procedure for the first cell when the SIB3 is not successfully decoded and a first duration is greater than a second duration of a SIB Wait Timer and returning to the step of determining whether any of the one or more SIBs are successfully decoded when the SIB3 is not successfully decoded and a first duration is less than a second duration of a SIB wait timer.

20. The apparatus of claim 12, wherein aborting the SIB reading procedure for the first cell further comprises:
attempting the SIB reading procedure on a next cell, wherein attempting the SIB reading procedure on the next cell further comprises:
performing the SIB reading procedure for a second cell for one or more SIBs of the second cell; and
performing the SIB reading procedure for a third cell for one or more SIBs of the third cell in response to aborting the SIB reading procedure for the second cell when the one or more SIBs of the second cell are not successfully decoded with the first time threshold; or
initiating a tune away to the second RAT.
